(19) United States
(12) Patent Application Publication
(10) Pub. No.: US 2019/0102850 A1
(43) Pub. Date: Apr. 4, 2019

(54) SMART CITY COMMODITY EXCHANGE WITH SMART CONTRACTS

(71) Applicants: David McMakin Wheeler, Gilbert, AZ (US); Ned M. Smith, Beaverton, OR (US); Thimas Barnes Abels, Beaverton, OR (US); Michael John Reed, Santa Clara, CA (US); Clair Michael Bowman, Beaverton, OR (US); Thomas John Barnes, Beaverton, OR (US)

(72) Inventors: David McMakin Wheeler, Gilbert, AZ (US); Ned M. Smith, Beaverton, OR (US); Thimas Barnes Abels, Beaverton, OR (US); Michael John Reed, Santa Clara, CA (US); Clair Michael Bowman, Beaverton, OR (US); Thomas John Barnes, Beaverton, OR (US)

(21) Appl. No.: 15/720,305

(22) Filed: Sep. 29, 2017

(51) Int. Cl. G06Q 50/18; G06Q 30/06; G06Q 20/12

(52) U.S. Cl. CPC G06Q 50/188; G06Q 20/12; G06Q 30/0611

(57) ABSTRACT

Embodiments involve using smart contracts in a decentralized network as a framework for a smart city commodity exchange. In at least one embodiment, consumers and service providers negotiate terms and conditions of a smart contract for providing goods or services to the consumer. The service provider may provide all requested goods and services or bundle goods and services provided from multiple vendors. Verification of smart contract fulfillment may be assisted by information from sensors or other independent data collection. The service provider may provide discounted services in exchange for information to provide to a third party. Resources of both the consumer and service provide are committed during smart contract negotiations until completion of the smart contract, or rejection of the offered terms. Resource commitments, smart contract generation, performance of the smart contract and intermediate transactions are recorded in public ledgers according to Blockchain protocols. Other embodiments are described and claimed.

### TECHNICAL FIELD

An embodiment of the present subject matter relates generally to network applications, and, more specifically but without limitation, to an automated and smart commodity exchange that uses a decentralized and distributed architecture.

### BACKGROUND

As more and more devices and things become network aware and connected, the opportunity grows for these things to become more involved in daily transactions and negotiations for services. Services become commodities that can be bid for, and traded on, in a public or private exchange using Blockchain or smart contract technologies. However, an infrastructure for secure commodity transactions does not yet fully exist in the marketplace.

Blockchain technologies are developing, but not yet as widely used as centralized mechanisms for ordering or purchasing goods and services. The Blockchain is known as an incorruptible digital ledger of transactions. Blockchain may be further described as a distributed system having a byzantine agreement algorithm for consistency. Unlike centralized systems, Blockchain technology uses distributed and shared documents and ledgers to store identical blocks of information across its network. As such, a Blockchain, as a general rule, is not controlled by any single entity and has no single point of failure.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating flow of information through a smart city commodity exchange, according to an embodiment;

FIG. 2 is a block diagram showing additional interactions with the smart city commodity exchange, according to an embodiment;

FIG. 3 is a block diagram illustrating a network having one or more smart city commodity exchanges, according to an embodiment;

FIG. 4 is a simplified flow diagram illustrating smart city commodity exchange negotiation and fulfillment, according to an embodiment;

FIG. 5 is a block diagram illustrating an example of a machine upon which one or more embodiments may be implemented;

FIG. 6 illustrates an domain topology for respective internet-of-things (IoT) networks coupled through links to respective gateways, according to an example;

FIG. 7 illustrates a cloud computing network in communication with a mesh network of IoT devices operating as a fog device at the edge of the cloud computing network, according to an example;

FIG. 8 illustrates a layers of a cloud network with fog components beneath a distributed smart city commodity exchange, according to an embodiment.

FIG. 9 illustrates a block diagram of a network illustrating communications among a number of IoT devices, according to an example; and

FIG. 10 illustrates a block diagram for an example IoT processing system architecture upon which any one or more of the techniques (e.g., operations, processes, methods, and methodologies) discussed herein may be performed, according to an example.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to using smart contracts in a decentralized network as a framework for a smart commodity exchange. A “smart contract” is a term of art related to Blockchain technology used to identify a trackable and enforceable agreement between parties. Also known as a cryptocontract, a smart contract may be implemented as a computer program that directly controls the transfer of digital currencies or assets between parties under certain conditions. A smart contract may define the rules and penalties around an agreement in the same way that a traditional contract does, but it may also automatically enforce those obligations by taking information input and assigning value to that input through the rules set out in the contract. Executing the actions required by those contractual clauses may result in information stored in a public ledger in a Blockchain to track performance and initiate automatic payments, or asset exchange, when conditions are met. Other protocols may use smart contracts, as well. In more general terms, in the industry, a smart contract is a computer protocol intended to facilitate, verify, or enforce the negotiation or performance of a contract or agreement between parties.

In an example, the commodity exchange is limited to a geographical area, or city that subscribes to the exchange. In at least one embodiment, a high-level process for building a commodity exchange, leveraging trusted execution security technologies, Blockchain and smart contracts to enable machine-to-machine (M2M) construction, bidding, reservation, and fulfillment of physical and logical services are described. This disclosure identifies specific processes and usage models where other mechanisms for security, networking, and Blockchain space, may be leveraged to construct a novel ecosystem for commodity and services exchange for smart cities, smart homes/building, and smart industrial systems. Examples herein refer to a smart city commodity exchange (SCCE), but implementations may vary and be associated with areas larger or smaller than a city, for instance, a metro region, a state, a country, an office building, a county, a sport arena, a park, etc. An embodiments of a SCCE may be used in real time for the specified geographic location.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Smart city ecosystems are a platform for commerce and information exchange. They are expected to be open and accessible to free enterprise providers of goods and services. In some instances, it may be illegal to exclude public participation or to unfairly bias participation. “Smart cities” is an industry buzz word that implies many of the public and private institutions will deploy automation technology that senses and controls a wide variety of informational and operational assets. Both information and operational assets may be exploited by the public and private sectors, enabling free market movement to fill a need.

However, operational assets may have safety, security and availability requirements that require proper vetting of service providers (whether public or private). Informational assets may facilitate unfair competition in the form of exclusive access that may, for example, give a competitor early access to data that is time sensitive. It is the equivalent to insider trading for information flow.

Fairness in smart cities ecosystems is an essential property of information exchanges, but fairness does not happen automatically. The information infrastructure must incorporate fairness behaviors in such a way that all participants equally benefit and are equally disadvantaged. A decentralized network, such as used with Blockchain, may provide more fairness than a centralized network controlled by a single entity.

In an embodiment, an SCCE operates in a decentralized network, where physical and logical services may be bought, sold or leased by persons or devices, though a public or private exchange. Embodiments as described herein create an ecosystem for commodity and services exchange using Blockchain based smart contracts that may be executed within trusted execution environments. Some advantages of this ecosystem are:
a fair environment for trusted exchange of services;
secure guarantees of payment through Blockchain transactions;
smart contracts (contracts with execution and fulfillment rules) tied to Blockchain for trust and security;
machine-to-machine (M2M) service interaction; and
governmental, regulatory or monitoring oversight.

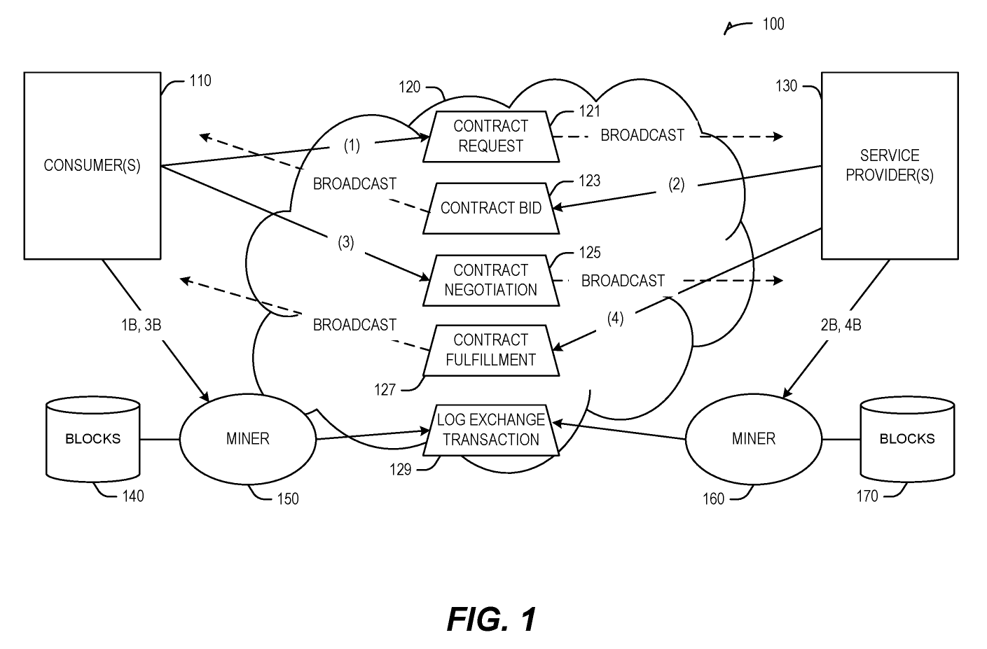

FIG. 1 is a diagram illustrating flow of information through a smart city commodity exchange 100, according to an embodiment. In an embodiment, one or more consumers 110 identify a need and send a contract or service request 121 at (1) to a smart city network 120. It will be understood that a contract or service request is a request to form an agreement, or request for offer/bid to another party for services, which may or may not include actual goods or commodities. The contract request 121 includes details of the requested goods or services, and criteria for fulfillment. Any variety of goods and services may be requested, such as: museum entrance fee, tours, bicycle rental, taxi or shared ride services, public transportation (e.g., bus, train, subway), WiFi access, local street conditions, town planning data (e.g., parades, construction, closures), and many more. The contract request 121 may be broadcast to one or more service providers 130. Broadcasts are logged in an exchange Blockchain 140 at (1B) and rely upon a consensus algorithm that establishes agreement among miners 150, 160 that the broadcast was made. One or more service providers 130 may return a contract bid 123 at (2). A contract bid may be seen as an answer to the service request as an offer of services and/or goods). In an embodiment, the contract bid 123 may be sent directly to the consumer requesting the contract (e.g., unicast). In another embodiment, the contract bid 123 may be broadcast to the group of all consumers 110 in the network, for instance, if the contract bid 123 is a general offer that others may desire. In another embodiment, the contract bid 123 may be sent to a subset of consumers 110 based on set preferences, contextual information, or contract request constraints, such as location, credit rating, previous transactions, etc. The Blockchain miner 160 records the bids 123 in the block 170 at (2B). The contextual information may be found in ledgers identifying the consumer 110 and the associated data. In some embodiments, the consumer identities are anonymous, even in ledgers, unless identification is required to complete the transaction.

It should be noted that the term broadcast is not used in a limiting sense of information pushed out to entities. Instead, in Blockchain systems, broadcast may be a more passive method of obtaining information. For instance, to broadcast an item refers to the concept that a hint or index value may be shared with a broad base of participants, thus allowing participants to have a roughly equal opportunity to access the Blockchain (ledgers) to learn of a relevant update. In other words, the information is made available with hints or indices, and the participants may pull the data from the network. Alternatively, participants may simply monitor all transactions as a miner node and use that to feed their analytics processing. The former makes it easier for those who do not want to setup or operate a monitoring capability to have roughly equal access to public information.

It should be understood that in industry terminology, a ledger may also be referred to simply as a Blockchain. These terms are generally synonymous. The term ledger is used herein to more easily distinguish between the Blockchain protocol or framework (e.g., records saved in the blocks-ledgers) with Blockchain protocols, etc.

Once the requesting consumer 110 has received the contract bid 123, contract negotiation 125 may commence. While the term contract negotiation is used herein, the term simply means a negotiation between a consumer and provider based on requested services/goods and offer for services/good, where the result includes rules and conditions for fulfilling the exchange. In an example, the consumer 110 may choose to accept the contract bid 123 and indicate this in the negotiation response at (3). In another example, the consumer 110 may choose to modify the requested contract term in the contract request 121, for instance if no responses are returned, or only unacceptable terms are returned in the contract bid 123. The consumer 110 may respond to the bid(s) negotiating compensation for service offerings (3) that are then broadcast back and miners 150, 160 record the negotiating transactions to blocks 140 and 170, respectively. Eventually, the negotiation ends. When a contract is committed by both the consumer 110 and provider 130, the commitment is recorded by the Blockchain at (3B and 4B). All broadcast traffic may be logged by miners 160, forming a historical, public record of an exchange activity.

Traditional contract law canon effects a rejection of the offer when a counter offer is made (e.g., interpreted as a rejection and a new offer). However, embodiments of the smart city commodity exchange may differ on their implementation of this scenario. In an embodiment, when the consumer 110 sends a contract request 121, consumer resources to be used for the goods or services may be temporarily committed, e.g., placed in escrow, until the contract negotiation 125 is complete. This way, the consumer 110 cannot spend the same money twice. The resource commitment may be entered into a public ledger in block 140 by miner 150 at 1B. In Blockchain terminology, “mining” is the process by which transactions are verified and added to a Blockchain. This process of solving cryptographic problems using computing hardware may also trigger the release of cryptocurrencies, such as bitcoin. Mining refers to the distributed computational review process performed on each “block” of data in a “Blockchain.” This allows for achievement of consensus in an environment where neither party knows or trusts each other.

When a service provider sends a contract bid 123 for goods or services, those resources may be temporarily committed in a public ledger stored in block 170 by miner 160, at 2B, e.g., placed in escrow. For example, the identifier associated with the good or contract number associated with a service agreement may be recorded to Blockchain blocks 140, 170 with annotation or status indicating that the items are temporarily in “escrow,” pending completion or abortion of the contract negotiation step. This way, the service provider cannot promise the same goods or services to two consumers at once. It should be noted that the public ledgers rely on Blockchain technology and are repeated across the network as identical copies, as needed. Thus, changing one ledger will change them all, so the consumers 110 and service providers 130 cannot secretly release their resources to entertain multiple, but unrelated negotiations. For instance, Blockchains implement a class of algorithms called practical byzantine fault tolerance (PBFT) whose main objective is to ensure each node in the mesh has a consistent copy of the distributed data set. In another embodiment, if a counter offer is sent during contract negotiation 125, resources may be released and recommitted at new levels, or released until a reply to the counter offer is made. There are risks to releasing the resources until a negotiation is complete, however. There may be a changeable parameter in the SCCE regarding rules on resource commitment. Thus, the commodity exchange may be implemented differently to accommodate local customs and regulations regarding release of resources.

Once the contract negotiation 125 reaches agreement between parties, the contract terms may be broadcast to service providers 130 so that no additional bid will be entertained. In an embodiment, the contract negotiations result in a smart contract. The smart contract includes all verifiable terms, and may trigger payment once fulfillment of the conditions is verified. It should be noted that a variety of digital currency types may be used as “payment” that are made available as digital currency, such as bitcoin, an identified barter item, item for trade, subscription, promise to pay later, immediately convertible cash currency, personal information, other digital data, etc. Appropriate resources are committed, or recommitted, to the blocks 140, 170, along with the negotiated terms, or smart contract, into public ledgers. Contract fulfillment 127 may be at completed (4) and verified by miners 150, 160. In typical Blockchain environment, each step of contract is written to the Blockchain (1B, 2B, 3B, 4B) making the progress a matter of public record. When contract fulfillment 127 (4) is completed, the public record reflects this. Since each miner 150, 160 agrees to the transaction, it is difficult for an attacker to assert differently. Payment is made based on the trust that the community of miners that reach a consensus is a viable basis for trust.

Contract fulfillment 127 may be broadcast to the consumers 110 with a verification request so that the payment committed to the smart contract may be automatically debited and paid. When the consumer 110 redeems the contract at (4), resulting in fulfillment of the contract terms, a ledger entry may be recorded to the block 170 at 4B which may initiate the payment. If the transaction requires multiple pieces or steps, each incremental fulfillment may be recorded in the block 170 until all terms have been met. When the transaction is complete, the transaction exchange may be logged 129 and stored in blocks 140, 170. In other words, service provider 130 relied on the ledger recording 4B to make the contract fulfilment 127 (4) a matter of public record (e.g., in the Blockchain). The broadcast to consumers 110 is a hint, or a nudge, used by the consumers 110 to query the Blockchain to identify a consensus of ledgers recording the contract fulfillment 127. For example, verification may be recorded as a hash value corresponding to a Merkle-tree node that points to the block in the Blockchain of interest.

In an embodiment, a region or geographic area may implement its own local SCCE. In order to have access to the public ledgers, a consumer 110 or provider 130 may be required to subscribe, or set up an account, with the local exchange. Thus, a “public” ledger is viewable only by subscribers. In another embodiment, the SCCE may be open to anyone in the public and everyone may have access to the public ledgers. In an embodiment, when a dispute arises, the Blockchain serves as proof entailment for both automated and manual resolution.

Utilizing a central server to broadcast the contract request and facilitate with negotiations may enable better anonymity because brokers or miners will not typically have direct communication with the consumer. A centralized server may filter various ledgers selectable by the consumer, for instance, to select only local providers or certified providers, etc. However, using a centralized server may weaken fairness in the exchange. For instance, a central entity may be subject to manipulation by the system operational personnel or other “insiders,” successful attacks by malware, spying and manipulation by a single government (e.g., in which the servers' location is in within a geo-political jurisdiction) that may wish to manipulate the outcome.

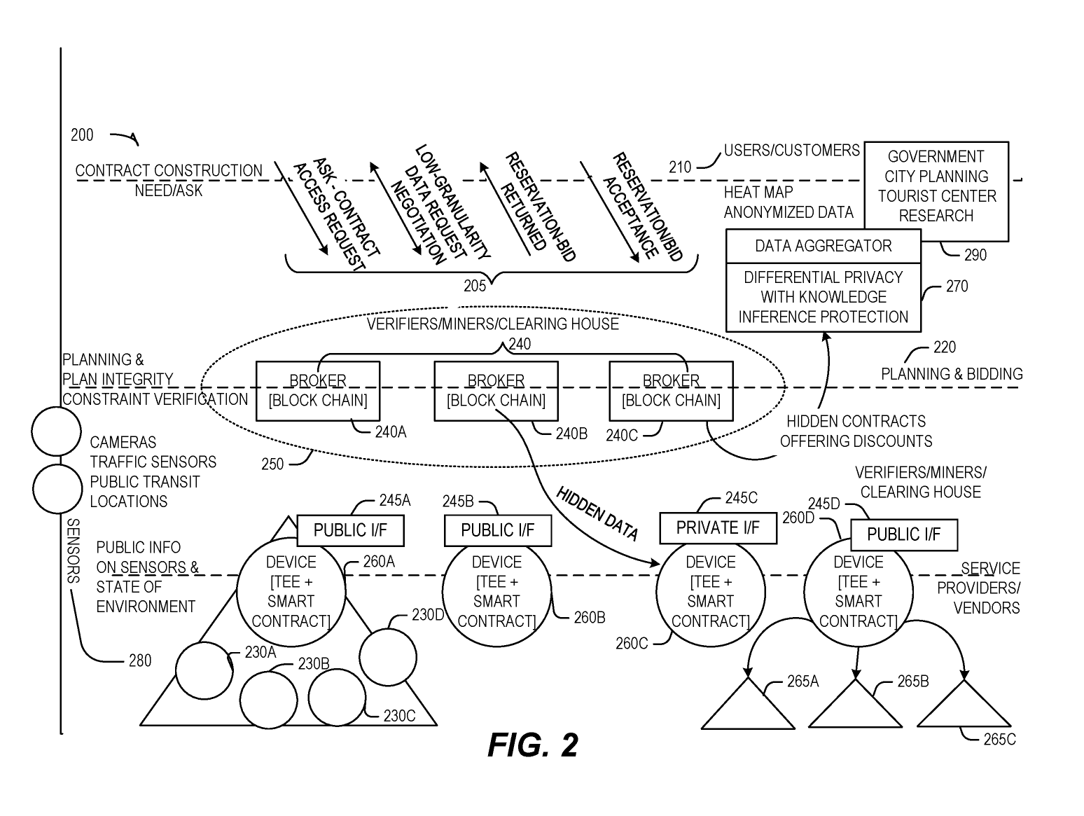

FIG. 2 is a block diagram showing additional interactions with the SCCE 200, according to an embodiment. In an embodiment, Blockchain technology is used to simultaneously record and publish activity commonly found in information exchanges. Requests for service may range from requests for transportation (e.g. ride-sharing, taxi service, public transportation service etc.); civil engineering projects (e.g. building, road, bridge construction); financial and public health services; and a variety of other goods or services, or combination thereof. The requests may all be made known through a Blockchain-based distributed information bus.

The process of bidding and awarding contracts, or agreements, to satisfy requests also occurs via Blockchains. A traditional bidding and contracts process may rely on a central broker entity that oversees bid submissions and assignment, reviews vetting and assignment of awarded contracts. These processes may be informed by background checks and queries that capture context (location, time, reputation etc.). Embodiments described herein decentralize the planning and bidding processes so that users/customers may be serviced by a broad spectrum of potential service providers. The service provider/vendor community may vie for the patronage of users who rely on automated agents that negotiate their interests in the exchange. In an embodiment consumer 110 and provider 130 may comprise automated agents, or may be driven by humans via a human-computer interface. Similarly, service providers/vendors rely on automated agents that negotiate their interests as well. The combination of these three components is the basis for machine-to-machine (M2M) smart city commodity exchange 200.

Embodiments described herein outline the operation of a SCCE where physical and logical services may be bought, sold or leased by persons or devices, through a public or private exchange. The interactions 205 represent the request, offer and negotiation processes between and among consumers 210 and service providers and vendors 260, 230, and 265, as described in conjunction with FIG. 1. In an example, devices 260 and 265 are examples of service providers (130). Service providers may aggregate a network of sensors 280 where aggregate data are appropriate for consumption via a public interface 245. In the example of FIG. 2, circles 230 represent a subset of sensors 280 that are securely accessible by a device 260A. A device 260D may further be accessed by other devices 265, forming a sensor network or MESH of devices. At least one of the devices 260 in the sensor network/MESH may represent the other devices 265 on the information exchange. It should be noted that it is customary among sensor network designs to use a triangle to represent a sensor network consisting of sensors/actuators and controller. Contrast this shape with a “cloud” shape that is commonly used to represent functionality in a server accessible via a public Internet. Furthermore, service providers 260, 265 may comprise a hierarchy of service providers where a middle-man service provider adds value to some other community of service providers 265 who rely on a root service provider 260 as their interface into the clearing house 250.

At the top of FIG. 2 are persons or devices (e.g., users and customers) 210 that have need of a particular item or service. Users/customers 210 are clients (e.g. members) of the exchange 200. These clients 210 interface to an exchange 200 that provides planning and bidding 220 for service providers, or brokers 240, shown along the dashed line in the middle of the diagram. Service providers and vendors are shown along the bottom, in more detail, as circles and triangles 230, 260 and 265. Some services may be private to a particular exchange, or may be publically available. In an example, a device 260A represents a provider running within a trusted execution environment (TEE) and is available via a public interface 245A. A TEE may take the form of a variety of trusted environment products, such as, but not limited to: Arm TrustZone®; Intel® SGX; Intel® VT-X; Intel® ME/DAL; Intel® SMM; TCG TPM; an HSM (hardware security module); a baseband management controller (BMC); or a constrained device that is hardened (e.g. Atmel crypto processor).

This device 260A may represent a service provider that is capable of providing and negotiating services or resources for multiple vendors, businesses, or other service providers, or be able to provide multiple services itself, utilizing securely accessible sensors 230A-D. In an example, provider 260B runs on a device with a TEE and negotiates only for services it can provide, via a public interface 245B. In an example, provider 260C runs on a device with a TEE and negotiates only for services it can provide, but via a private interface 245C. A service provider may offer a service that is sensitive, or classified. For example, operation of a nuclear power plant may wish to hide controllers and service providers from public view, for safety reasons. In a private interface, some negotiation may be with data hidden to the public, where offers may be unicast to authorized devices rather than broadcast. Encryption may play a role in restricting access to data that is exchanged via the clearing house but not open or required for public consumption. For example, information not required for public consumption may be encrypted in a private interface, such as patient records showing disease outbreak pathology, or hedge fund transactions where a hedge fund derivative is being exchanged on the public clearing house. In an example, provider 260D represents a service provider that can negotiate for vendors 265A-C and provide an aggregation of offerings. In this example, service providers 265 may not be able to negotiate on their own and need assistance from the device 260D. For instance, in an embodiment, provider 260D may offer a package that includes a metrorail (e.g., light rail or subway) day pass, zoo entrance, lawn seats to a concert, etc., for multiple vendors. The ensuing smart contract may include conditions that provide a refund for delayed rail service, or exchange to a ride sharing/taxi service in the case of rain, and also provide a percentage refund of the concert ticket based on inclement weather at the concert site, etc. As discussed above, it will be understood that the service providers 260A-D may represent a single service, a conglomeration of services (e.g. a package) or may represent multiple other services or vendors.

In an embodiment, a broker 240 may broker a deal, or smart contract, with any service provider having a public interface 245A, 245B, 245D. However, only an authorized broker 240B may broker a deal with a provider 260C having a private interface 245C. It will be understood that to ensure secure transactions brokers 240 or service providers 260 should execute in a trusted execution environment (TEE).

In an embodiment, environmental sensors, event monitors, and/or data collection and delivery devices (shown along the left hand side as sensors 280) provide data to clients 210, the exchange 200, and/or service providers, vendors or brokers 260, 230, 240. The exchange 200 is the set of users 210, brokers 240 and devices 260 that negotiate a contract following the distributed protocols embodied in 205. Items such as 220, 270, 290, 280 and 265 are illustrated for ancillary or explanatory purposes. It should be noted that the topology of vendors and providers via public/private interfaces 245 may vary widely, and the specific configuration of vendors, service providers and sensor networks 260, 265, 230 are shown here for illustrative purpose. The sensors 280 may offer information that affects the availability or usefulness of services. For instance, in an example, if a weather sensor indicates an unexpected weather front is approaching with rain, taxi or shared ride services may be preferred over a bicycle rental service. Information gathered from sensors 280 may assist in enforcement or automatic triggering of certain smart contract conditions. For instance, an example smart contract for concert tickets on the lawn may provide for a discount for rain. In an example, sensor data local to the concert venue may record rain and forward this information to the SCCE brokers or be recorded in a ledger associated with current smart contract conditions.

In various examples, weather data may be associated with the location of the consumer 110 or venue (not shown), or consist of more general data from the local or national weather service for a general area, or be received via crowdsourcing for a specific, pre-negotiated location. If the smart contract includes an inclement weather condition, the receipt of the weather information may immediately trigger a fulfillment level, or provide a refund. In an example, a smart contract for bicycle rental may include a weather condition enforceable based on sensors 280 capturing data when the bicycle is in the vicinity of the sensor. If it rains, the smart contract may provide a discount or a coupon for taxi or other transportation services.

Various sensors 280 may collect data that helps the brokers 240 bundle various services and make low risk conditions. For instance, a consumer may be currently located on one side of town and plan to attend a theatrical production in the evening. The user may have some number of free hours available before attending the theater production, and request brokers to offer a package for a museum visit, entertainment, transportation, theater tickets and dinner reservations near the theater, etc. Sensors 280 may provide traffic and weather information to the broker 240 to assist in an offer that can be accomplished based on expected travel time, weather, etc. For instance, if rain is expected or occurring, the broker 240 may offer taxi service discounts rather than bicycle or bus options. A broker 240 may guarantee on-time dinner reservations to provide sufficient time to eat before the theater. The broker 240 may suggest a museum closer to the theater if traffic is expected to be bad close to dinner or theater time. Sensors or data collection devices at the restaurant may track the consumer's time of arrival, departure, or payment for dinner, etc. If the consumer arrived at the restaurant on time, but was not served or checked out at the guaranteed time, the broker may automatically provide a refund or coupon, based on the conditions in the smart contract.

Contract requests sent by a user/customer 210 may include open ended desires or requirements. For instance, existing systems for hotel reservations allow a user to select the city/location, number of guests, number of nights, foam pillows, low floor, high floor, near elevators, accessible rooms, etc. However, there is no way to enter a special request that can provided without human review. In an embodiment, a user/customer 210 may include non-standard conditions such as a location that is less than a 15 minute walk from a venue, but if rain is expected, then less than a 5 minute walk to the venue. A user/customer might require that the hotel is within two subway stops of a 4-star rated Japanese Sushi restaurant. Traditional systems are unable to process this kind of request. Embodiments of the SCCE may include natural language processing agents to parse the special requests and create a list of rules. An automated broker 240 may use these rules, along with sensor data (e.g., traffic cameras, weather sensors), weather predictions, city maps with rail stops, online restaurant reviews to find alternative offers that meet some or all of the user's requests. In an embodiment, the special requests may be formatted using JSON (JavaScript Object Notation) to facilitate machine understanding of the request. In some cases, special request may be undecipherable by an automated agent and be forwarded to a human agent for input.

In an embodiment, public or private research or government agencies 290 collect data associated with service requests and/or service consumption in exchange for discounts or other benefits. In an example, the agency 290 may be one of a governmental agency, tourist agency, research organization, regulatory agency, local chamber of commerce, trade association, service provider conglomerate, or other quasi-governmental or local business cartel-like organization. For example, a local city tourist board may offer a 10% discount for local museums, if the client shares anonymized planning and reservation data. Sharing of this data may be seen as in the public interest for the government or municipal entity to better understand what brings tourists to local venues, or to promote underutilized services or attractions in the city. Mandatory sharing of reservations may be required by government agencies for taxation and/or regulatory compliance, for instance for licensing of ride sharing type services such as provided by LYFT™ or UBER™; or online marketplace for hospitality or lodging reservation services such as provided by AIRBNB®.

In an embodiment, broker 240C may have a relationship with a government city planning or tourist center research organization 290. In an example, this relationship may be exclusive or non-exclusive (e.g., more than broker has this relationship). The broker 240C may interact with a data aggregator 270 to aggregate discounts or promotions with fulfillment of a smart contract, as requested by the consumer 210. In an example, the city planning, tourist center, or university research arm 290, may offer a bundle of public transportation passes with tickets to the zoo or aquarium, or similar. In an example negotiation, a consumer 210 requests a bid for tickets to the city aquarium. Broker 240A may not have a relationship with the city entity 290 and can only offer regularly priced tickets to the aquarium. But broker 240C may access the data aggregator and offer a bundle including bus passes and discounted aquarium tickets in exchange for some personal consumer information or feedback, such as, a promise to complete a survey, email address, city of origin, etc. The consumer 210 may wish to remain completely anonymous and choose the smart contract offered by broker 240A, or accept the terms to provide the personal information and accept the smart contract with a deeper discount offered by broker 240C. In an embodiment, the entity 290 pays broker 240C a fee for providing the authorized personal information of the consumer 210. In an embodiment, the broker 240C shares anonymized information with the entity 290, which may be aggregated over many consumers or comprise individual data. In this example, authorization by the consumer to share the anonymized data may not be required, but still enable broker 240C to provide deeper discounts, offset by the payments from the entity 290.

In an embodiment, the exchange may provide services in a smart building to hotel guests (e.g. towel delivery by robot or autonomous delivery system, food delivery by local eateries, access to concierge levels or pools/gym, etc.), apartment residents (e.g. charge for parking, checkout of pool or lawn games, activation of tennis or basketball court lighting), or even industrial system under a private exchange, allowing more detailed tracking and trade-off of workloads in a dynamic smart factory providing services for multiple customers.

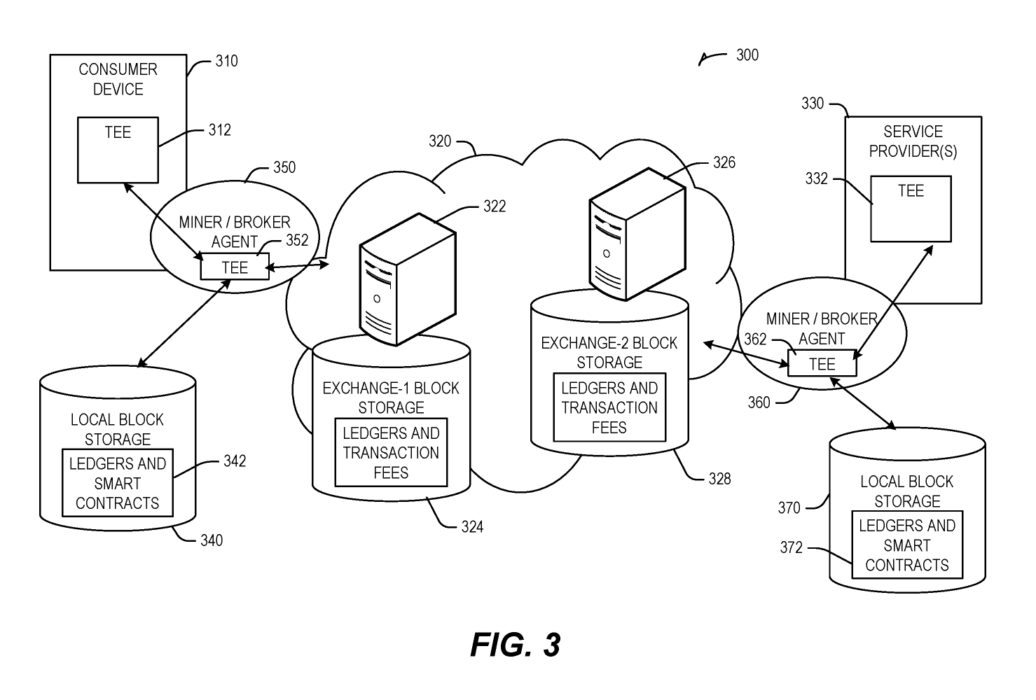

FIG. 3 is a block diagram illustrating a system 300 having one or more smart city commodity exchanges (SCCE), according to an embodiment. An SCCE system may provide an electronic automation system for coordinating public (e.g., government), private (e.g., non-government) interactions that are resistant to impropriety and manipulation (e.g., illegal or illicit). Closed (non-public) exchanges may be subject to a variety of threats by an insider. The insider may be a trusted entity that is supposed to balance the self-interest of both public and private entities. However, history reveals that such trusted entities are corruptible, hence the assertion of a trusted 3rd party may not exist in practice. This SCCE approach as described herein may rely on the correct operation of the distributed computing algorithms implemented across many nodes to replace the notion of a trusted 3rd party. The set of data, services, contracts, etc., may be open ended and not limited by embodiment described herein. For context, an application may wish to enumerate a spectrum of interactions typically associated with public/private partnering. (e.g. highway construction, transportation supply/support/maintenance, energy, healthcare, fire/police protection, emergency services, defense contracting, education, etc.).

In an embodiment, an SCCE may be implemented as a turnkey system in a network 320. In an example, an SCCE 322 may be implemented for Portland, Oreg. and surrounding areas. A second SCCE 326 may be implemented for Philadelphia, Pa. and surrounding area. As discussed above, parameters may be set for local customs and regulations for each SCCE 322, 326. In the illustrated example two distinct servers 322, 326 are illustrated to represent the two SCCEs. However, it will be understood that multiple exchanges may be implemented on a single server, or an individual SCCE may have various functions distributed or mirrored among multiple servers. Each SCCE 322, 326 may have its own local block storage 324 and 328, respectively. The local blocks 324, 328 may store ledgers and transaction fee information. It will be understood that aspects of the SCCE execute in a TEE on the server 322, 326. The SCCE may provide the framework for a local commodity exchange and facilitate negotiations among consumers, providers and governmental or research organizations for a specific locale, as discussed above. In another embodiment, the SCCE servers 322, 326 may provide the protocols and local rules, or pass through the sensor and collection data for enforcement of the smart contracts. In an embodiment, each completed transaction may provide a transaction fee to the SCCE system.

In an embodiment, SCCE nodes may provide compute nodes for hosting the exchange workload. These compute nodes may be hosted in a commercially available cloud service, or in a privately contracted supplier server, or may be an implemented as an ad-hoc mesh of computing nodes. For example, the Blockchain miners may also supply compute resources for the SCCE workload.

In an example, a consumer device 310 is a node on a network and includes a TEE 312 used for interactions with the blocks, ledgers and smart contracts. An automated local miner or broker agent 350 includes a TEE 352 to communicate with the consumer device 310 and entities within the network 320. In an example, the miner/broker 350 operates within a TEE 352 using Blockchain protocols, and communicates with the other brokers, service providers, or governmental entities. Consumer-side miner/broker agent 350 may have a local block storage 340 for storing ledgers and smart contracts 342. The SCCE server 322, 326 may receive transaction fees built directly into the protocols for ledgers in the network. Service provider device 330 is a node on the network 300 and includes a TEE 332 for communication with the automated local miner/broker agent 360 operating in its own TEE 362, and using Blockchain protocols. The provider-side miner/broker agent 360 may have a local block storage 370 for storing ledgers and smart contracts 372.

In an embodiment, the SCCE 322, for instance, may operate in a similar fashion as other Blockchain environments, e.g., when ledgers are appended, the information is broadcast to all members on the network using cryptographic problems for access. In an embodiment, when transactions, resource commitments, fulfillments, transaction fees, etc., are recorded to a local block, the ledger information is broadcast to the SCCE network 300 so that other members may update their local ledgers. If a member has been offline for a time, then reconnection may initiate sending queries to the SCCE asking for updates. In another example, the member may just wait until updates are sent in the normal course if there is no need of immediate updates. It will be understood that even though only two SCCEs are illustrated in FIG. 3, more or fewer than two SCCEs may be available on the network. In an embodiment, a single SCCE may server multiple geographic areas, where the requests and other transactional ledgers identify a location and may not be forwarded to members outside of the specified geographical area.

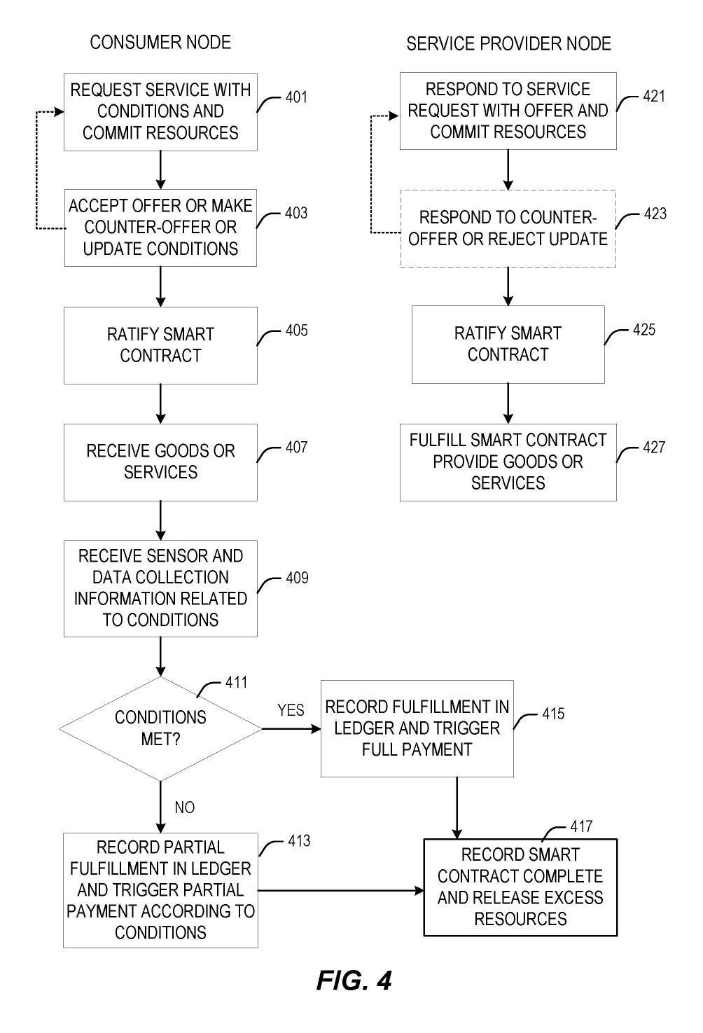

FIG. 4 is a simplified flow diagram illustrating SCCE negotiation and fulfillment, according to an embodiment. In an embodiment, a consumer sends a request for service (e.g., contract request or service request) to the SCCE, in block 401. The request may list a number of conditions, such as maximum cost, number of participants, specific goods or services included, weather or delay contingencies, desired activities, desired duration, desired geographic area or geo-fenced location, desired mode of transport, etc. Once the consumer has identified a maximum cost, payment resources may be committed and put on hold until contract fulfillment. The request and resource commitment are recorded in the SCCE ledger. This commitment of resources differs from existing Blockchain frameworks. In existing system, a consumer offers to purchase an item and the provider accepts the offer without a commitment of resources until the transaction is complete. For instance, if a consumer purchases a refrigerator from a merchant using Blockchain, once the refrigerator is delivered, payment may be automatically sent to the merchant, when fulfillment is recorded in the ledger. However, this existing method is risky because the consumer may not have the payment resources available by the time the transaction is complete, and there is no guarantee that the merchant has the desired goods immediately available when making an offer. Further, existing systems are not capable of generating a complex smart contract with conditions that are non-standard for the industry.

In a Blockchain environment, inventories may be tracked publically using the Blockchain ledgers. Vendors prove they have capacity to produce products at a certain rate by referring to Blockchain history showing completed transactions over a period of time involving the product in question. A commodity exchange may reference this data as collateral backing up their claim that the commodity exists, or will exist in the near future. The consumer buys a share in the commodity which is redeemable for the physical good when it is available. The Blockchain tracks shares outstanding, production of delivered goods (and the rate of production). Thus, the Blockchain helps manage risk because more of the manufacturing and production process, as well as, the buyer's ability to pay, is known with a relative confidence level based on forecasting from historical Blockchain data, in advance.

Once the request for service has been broadcast to the SCCE member network and recorded in the ledger, a service provider may respond with an offer of services and commit those resources using the ledger, in block 421. For instance, a consumer may want to rent 10 bicycles for the day. A rental entity that has only five bicycles available will not be able to commit 10, and cannot respond to the offer. Thus, the required commitment of resources enables a more trusted transaction negotiation. In some cases the provider may not offer exactly what the consumer desires. The consumer may receive offers from more than one provider for review. The consumer may accept the offer or make modifications to the request to entertain new offers, in block 403. It will be understood that if the new request has a different maximum cost that additional resources may be committed in the ledger. It will also be understood that if the consumer does not possess enough resources for payment that the SCCE may reject the request. Processes at blocks 401 and 403 may be repeated until the consumer receives an acceptable offer. The provider may respond to the counter offer or reject the updated offer in block 423. It should be noted that when a provider responds to a request with an offer, the resources are committed. If the consumer rejects the offer or provides a counter offer, then the providers resources may be released until an new offer is made. The provider may cycle through blocks 421 and 423 during the negotiation process.

In other words, auto-negotiation may be performed by automated agents of the service providers and consumers. The automated agents may have access to control bank funds of the consumer, as well, as inventory of the service provider, as specified in the Blockchain ledgers, as users have authorized.

In an embodiment, commitment of resource during negotiation with multiple offers may be accommodated. A worrisome scenario could be a case where multiple offers are made to a merchant, but the merchant must commit all of its inventory to meet one offer. That one offer may be rescinded or canceled, where the merchant could have satisfied one or more other offers. For instance, other offers are also observed by the Blockchain so it will not be a surprise to the vendor or other customers. If the second customer sees a condition where the vendor cannot keep up with demand, the second customer may voluntarily withdraw the offer. An overarching principle of the system is self-regulation based on self-interest that seeks to minimize risk). Risk is best managed when the unknowns are accounted for. The Blockchain levels the playing field since all sides must contribute to it in order to participate with it. The Blockchain itself is trustworthy because no central party can manipulate outcomes and the cost associated in getting a majority of Blockchain nodes to collude is greater than the potential value of the transaction(s) that are the target of manipulation. Even the total value of the exchange is known, and if the cost to collude is less than the value of the exchange, then this is known and participants can choose a different exchange.

In an embodiment, there may be a timeouts on the offer/acceptance so that resources are not locked up for too long. It is conceivable that a merchant may reserve more than their total inventory (e.g., similar to overselling seats on a plane). However, the merchant will be scrutinized in terms of total capacity. The number of sold tickets, for instance, and historical Blockchain ledger data that predicts the number of sold, but unused seating.

In an embodiment, returns and exchanges are themselves transactions that are accounted for by the exchange. Since transaction data are all accounted for on the Blockchain, analytics algorithms may discover seemingly risky supply and demand flows. The analytics suppliers may provide their insight as a product that others use to offset the risk, e.g., such as buying “futures” on a cancelled order or return.

In an example, a ticket reseller may buy your ticket and resell it to someone else. The ticket reseller may take a loss on some tickets but make up for it by charging higher prices on the tickets that do sell.

In an embodiment, if an event, such as a live band performance, is canceled, an insurance use case may be invoked. In an example, an underwriter may agree to buy back the unused tickets in exchange for an insurance premium (the band agrees to pay the premium). The insurer may set terms with the band to perform again within three to seven days and where the insurance company has greater freedom to set the ticket price. Alternatively, the band may assert that tickets are sold as “all sales final” effectively making the ticket holders the insurers.

An advantage of embodiments described herein is that there can be automation in place that performs risk assessment based on a rich set of available transaction data (e.g., from the Blockchain) and negotiates to the self-interest of the Consumer/Service Provider to arrive at the optimal risk/reward compromise.

Once an agreement is made between the consumer and provider, a smart contract, or digital agreement, encoded with the pre-conditions is generated and recorded in a ledger at blocks 405 and 425. It does not typically matter into which local ledger the smart contract is recorded because it will eventually be mirrored into all ledgers in the network. Some embodiments may require a consensus between the two smart contracts (e.g. consumer side and provider side) to effect a binding contract. In an embodiment, the ledger may be entered into the block with a reference identifier for the smart contract and not the actual contract. The parties to the transaction may store the complete smart contract on their local blocks without the details becoming public (e.g., hidden or encrypted).

The provider provides the goods or service and fulfills the contract in block 427. The consumer receives or consumes the goods or services in block 407. It should be understood that the smart contract may be made to bind more than one service provider when various goods and/or services are bundled into a single transaction. Thus, the service contract may be fulfilled in stages, for the various goods or services. A failure to fulfill by any party in the transaction may automatically trigger contingencies based on the pre-defined conditions. Fulfillment failures may be determined directly, or be based on sensor and data collection metrics, in block 409, and discussed above. The example flow shows the sensor readings to be received and analyzed against the conditions by the consumer. However, alternative embodiments may perform this analysis on the provider side or utilize a third party or local fulfillment agent for this. It should be noted that any third party that performs this analysis must be given access to the unencrypted version of the smart contract to access all of the conditions of service.

A determination of whether the conditions have been met is performed in block 411. If the conditions have been met, then the fulfillment is deemed complete and recorded as such in the ledger, in block 415. The ledger entry may automatically trigger full payment. If the conditions have not been met, a partial fulfillment may be recorded in the ledger and trigger a partial payment according the rules of the conditions in the smart contract, in block 413. Once the fulfillment or partial fulfillment are entered, the smart contract may be recorded as compete, in block 417, and trigger a release of excess resources, for instance for security deposits or unused/optional services.

In an embodiment, fulfillment of the smart contract may have a time limit. At the end of the time allotted, a determination may be made to assess the level of fulfillment. Some smart contracts may be impossible to complete due to circumstances beyond the control of the parties. Adding a time constraint to the smart contract enables unused resources to be released instead of holding them as committed, indefinitely.

In an embodiment, once negotiations are initiated, parties to the negotiation may be provided with a private key for the smart contract so that they have access to all conditions. For example, in cases where transaction data contains hidden or private data that is germane to the negotiation, the data may be protected from unauthorized access using public/private key technology. Participation in the negotiation may qualify the participant to obtain the protected data. For example, the encryption key may be shared with the participant at the appropriate step in the negotiation. For key exchange, the recipient's public key may be given to the data holder who encrypts the data with a symmetric key then encrypts the symmetric key with the recipient's public key. The recipient then decrypts the symmetric key with the private key. This exchange may occur in the context of the negotiation. At each offer from a provider, a new private key may be provided. Ledger transactions may be recorded with both public and private data. The private data requires a private key in addition to the public keys known in the network.

It should be noted that Blockchain technology relies on the use of asymmetric cryptography (private keys) to authenticate actions of the various users. Keys may not necessarily be associated with a human or legal entity in order to remain privacy preserving. However, all the transactions involving the same private key form a reputation that may be used to evaluate trust (risk) associated with interactions involving the key (entity). In an embodiment, the contract conditions may be disclosed publically to the Blockchain, meaning all block storage instances 340, 370 have access to the same conditions. While the ledgers may be repeated for multiple blocks, there is no “second set of books,” so to speak. The ledgers may be synchronized using the byzantine agreement algorithm. Thus, all prospective service providers may vie for a contract on a level playing field. The private key, as described above may be associated with the Blockchain. However, a consumer device 310 or service provider 330 might use its private key to contribute conditions to the Blockchain.

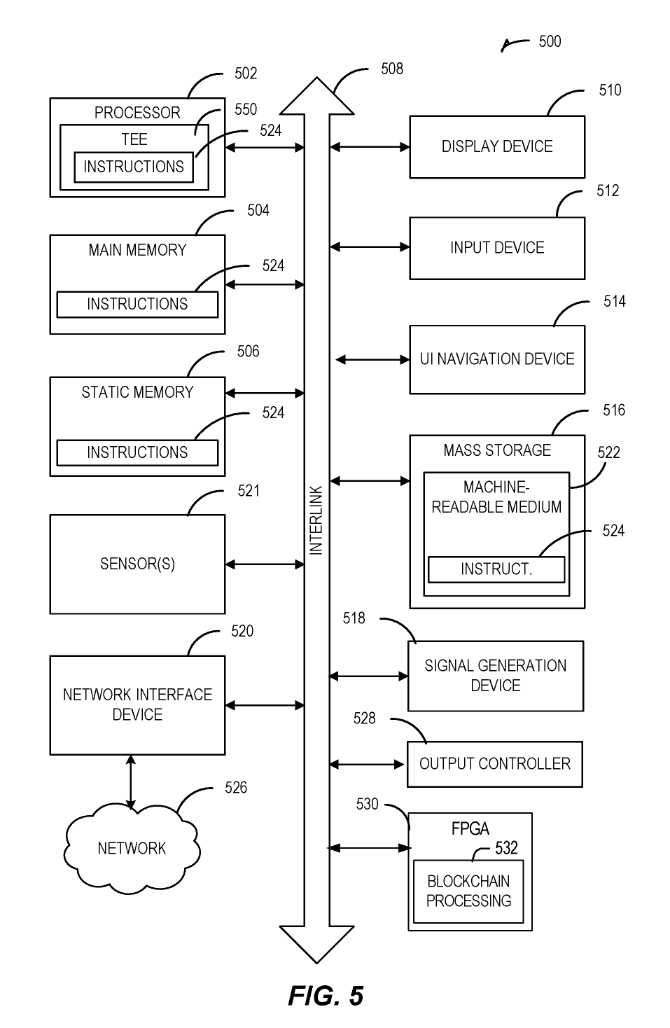

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media. In an example, instructions 524 operate within a trusted execution environment (TEE) 550, for secure processing.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

In an embodiment, network interface device 520 may include instructions to implement broker/Blockchain functionality (e.g., FIG. 2, 240) as embedded instructions. Similarly, it should be understood that instructions to implement the broker/Blockchain functionality 240 may be implemented as instructions 524 in machine readable medium 522, in a secure or isolated storage area. For instance, instructions 524 may be encrypted when outside of a TEE or secure embedded controller such as network interface 520. In an embodiment, a field programmable gate array (FGPA) 530 may be programmed to implement the broker/Blockchain functionality 532, or other subsystem implementing a portion of the functionality described herein. In an embodiment, the FPGA 530 may be connected through a subsidiary bus to memory 506,516, or any of the network controllers 520, or both. In an example, the FPGA 530 may have direct memory access to communications buffers.

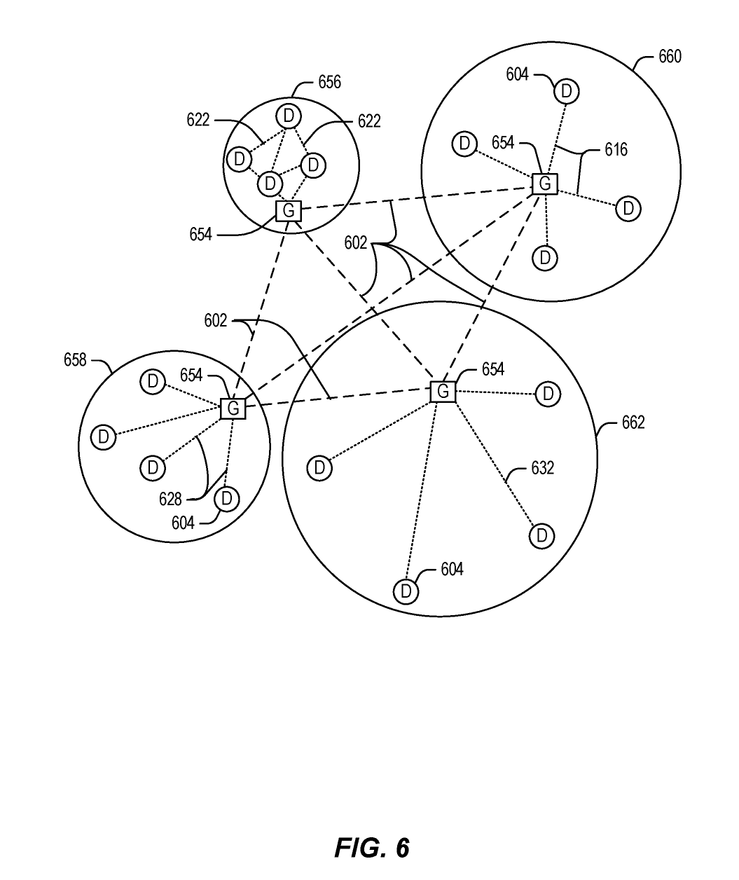

FIG. 6 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet. In embodiments, various IoT devices may collect information to be exchanged via a competitive data market.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

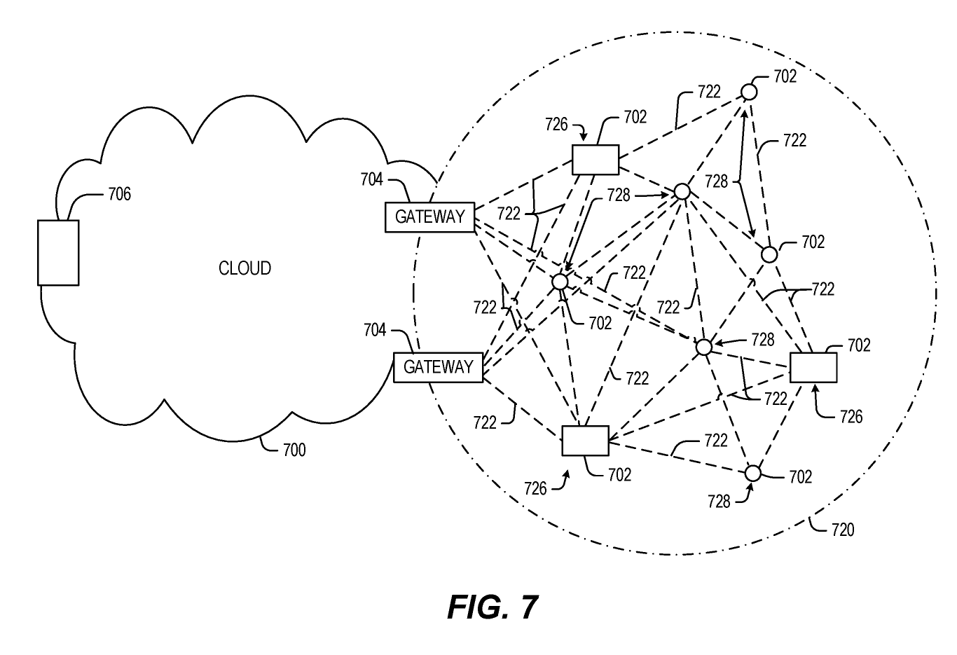

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIG. 6 and FIG. 7, present a number of new challenges in a heterogeneous network of connectivity comprising a combination of wired and wireless technologies.

FIG. 6 specifically provides a simplified drawing of a domain topology that may be used for a number of internet-of-things (IoT) networks comprising IoT devices 104, with the IoT networks 656, 658, 660, 662, coupled through backbone links 602 to respective gateways 654. For example, a number of IoT devices 604 may communicate with a gateway 654, and with each other through the gateway 654. To simplify the drawing, not every IoT device 604, or communications link (e.g., link 616, 622, 628, or 632) is labeled. The backbone links 602 may include any number of wired or wireless technologies, including optical networks, and may be part of a local area network (LAN), a wide area network (WAN), or the Internet. Additionally, such communication links facilitate optical signal paths among both IoT devices 604 and gateways 654, including the use of MUXing/deMUXing components that facilitate interconnection of the various devices.

The network topology may include any number of types of IoT networks, such as a mesh network provided with the network 656 using Bluetooth low energy (BLE) links 622. Other types of IoT networks that may be present include a wireless local area network (WLAN) network 658 used to communicate with IoT devices 604 through IEEE 802.11 (Wi-Fi®) links 628, a cellular network 660 used to communicate with IoT devices 604 through an LTE/LTE-A (4G) or 5G cellular network, and a low-power wide area (LPWA) network 662, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into fog devices or systems. As the use of such improved technologies grows, the IoT networks may be developed for self-management, functional evolution, and collaboration, without needing direct human intervention. The improved technologies may even enable IoT networks to function without a centralized control system. Accordingly, the improved technologies described herein may be used to automate and enhance network management and operation functions far beyond current implementations.

In an example, communications between IoT devices 604, such as over the backbone links 602, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous operation and coordination of service delivery against contractual service objectives, orchestration and quality of service (QoS). Distributed control supports swarming and fusion-of-resources believed to be important aspects of a distributed information market based on currying. Some of the individual examples of network-based resource processing include the following.

The mesh network 656, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 658, for instance, may use systems that perform standards conversion to provide multi-standard connectivity, enabling IoT devices 604 using different protocols to communicate. Further systems may provide seamless interconnectivity across a multi-standard infrastructure comprising visible Internet resources and hidden Internet resources.

Communications in the cellular network 660, for instance, may be enhanced by systems that offload data, extend communications to more remote devices, or both. The LPWA network 662 may include systems that perform non-Internet protocol (IP) to IP interconnections, addressing, and routing. Further, each of the IoT devices 604 may include the appropriate transceiver for wide area communications with that device. Further, each IoT device 604 may include other transceivers for communications using additional protocols and frequencies. This is discussed further with respect to the communication environment and hardware of an IoT processing device depicted in FIGS. Error! Reference source not found. and 10.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 7 below.

FIG. 7 illustrates a cloud computing network in communication with a mesh network of IoT devices (devices 702) operating as a fog device at the edge of the cloud computing network. The mesh network of IoT devices may be termed a fog 720, operating at the edge of the cloud 700. To simplify the diagram, not every IoT device 702 is labeled.

The fog 720 may be considered to be a massively interconnected network wherein a number of IoT devices 702 are in communications with each other, for example, by radio links 722. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 702 are shown in this example, gateways 704, data aggregators 726, and sensors 728, although any combinations of IoT devices 702 and functionality may be used. The gateways 704 may be edge devices that provide communications between the cloud 700 and the fog 720, and may also provide the backend process function for data obtained from sensors 728, such as motion data, flow data, temperature data, and the like. The data aggregators 726 may collect data from any number of the sensors 728, and perform the back end processing function for the analysis. The results, raw data, or both may be passed along to the cloud 700 through the gateways 704. The sensors 728 may be full IoT devices 702, for example, capable of both collecting data and processing the data. In some cases, the sensors 728 may be more limited in functionality, for example, collecting the data and allowing the data aggregators 726 or gateways 704 to process the data.

Communications from any IoT device 702 may be passed along a convenient path (e.g., a most convenient path) between any of the IoT devices 702 to reach the gateways 704. In these networks, the number of interconnections provide substantial redundancy, allowing communications to be maintained, even with the loss of a number of IoT devices 702. Further, the use of a mesh network may allow IoT devices 702 that are very low power or located at a distance from infrastructure to be used, as the range to connect to another IoT device 702 may be much less than the range to connect to the gateways 704.

The fog 720 provided from these IoT devices 702 may be presented to devices in the cloud 700, such as a server 706, as a single device located at the edge of the cloud 700, e.g., a fog device. In this example, the alerts coming from the fog device may be sent without being identified as coming from a specific IoT device 702 within the fog 720. In this fashion, the fog 720 may be considered a distributed platform that provides computing and storage resources to perform processing or data-intensive tasks such as data analytics, data aggregation, and machine-learning, among others.

In some examples, the IoT devices 702 may be configured using an imperative programming style, e.g., with each IoT device 702 having a specific function and communication partners. However, the IoT devices 702 forming the fog device may be configured in a declarative programming style, allowing the IoT devices 702 to reconfigure their operations and communications, such as to determine needed resources in response to conditions, queries, and device failures. As an example, a query from a user located at a server 706 about the operations of a subset of equipment monitored by the IoT devices 702 may result in the fog 720 device selecting the IoT devices 702, such as particular sensors 728, needed to answer the query. The data from these sensors 728 may then be aggregated and analyzed by any combination of the sensors 728, data aggregators 726, or gateways 704, before being sent on by the fog 720 device to the server 706 to answer the query. In this example, IoT devices 702 in the fog 720 may select the sensors 728 used based on the query, such as adding data from flow sensors or temperature sensors. Further, if some of the IoT devices 702 are not operational, other IoT devices 702 in the fog 720 device may provide analogous data, if available. In an embodiment, the fog network 720 and cloud network 700 may be termed a sensor network, as described below.

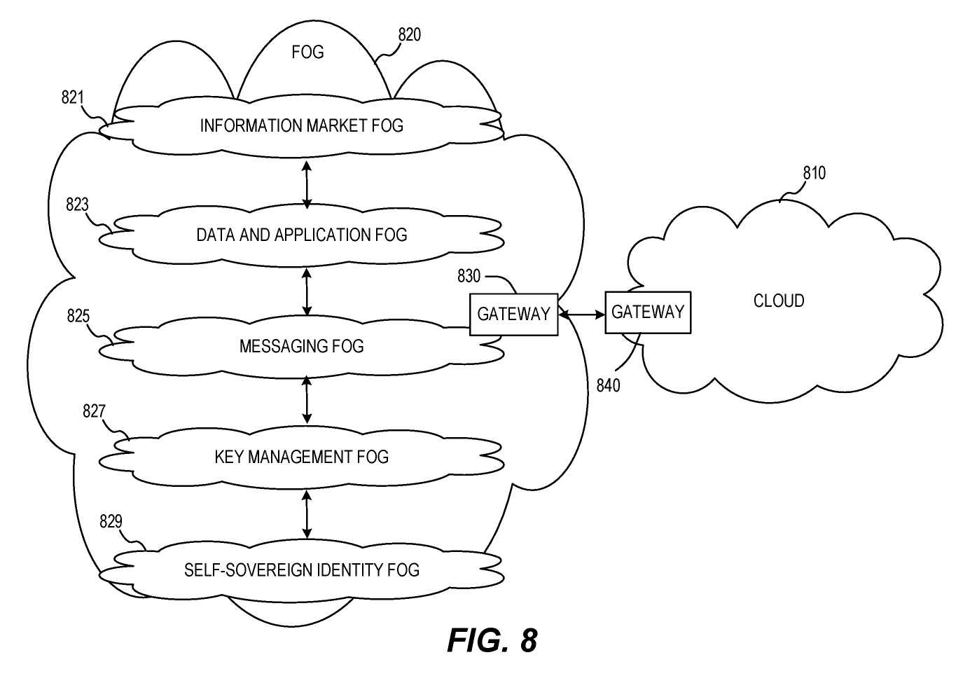

FIG. 8 illustrates a layers of a cloud network with fog components beneath a distributed information market, according to an embodiment. For instance, cloud 810 may communicate with fog 820 via gateways 830 and 840. The fog 820 may refer to a network that operates behind a gateway 830, privately. Cloud 810 may have the same functional layers as the fog 820 but cloud layers may take place in public, that is to say on a third party computer network, such as Amazon Web Services (AWS) available from Amazon.com.

In an embodiment, the SCCE as described herein may function exclusively in a cloud environment. But operation may be distributed across many Blockchain nodes where each fog layer 821, 823, 825, 827 and 829 has the ability to coordinate and synchronize a distributed state according to one or more Blockchain systems. This is also known as distributed byzantine agreement and fault-tolerant byzantine agreement.

The fog embodiment 720 (FIG. 7) may be realized using the layers information market fog 821, data and application fog 823, messaging fog 825, key management fog 827 and self-sovereign identity fog 829 as shown. Cloud 700 (FIG. 7) may comprise similar layers, but are hosted on publicly visible hosting services. Conceptually, the differences between a fog 820 and a cloud 810 are esoteric. Another name for fog 820 may be “private cloud” or “distributed private cloud.”

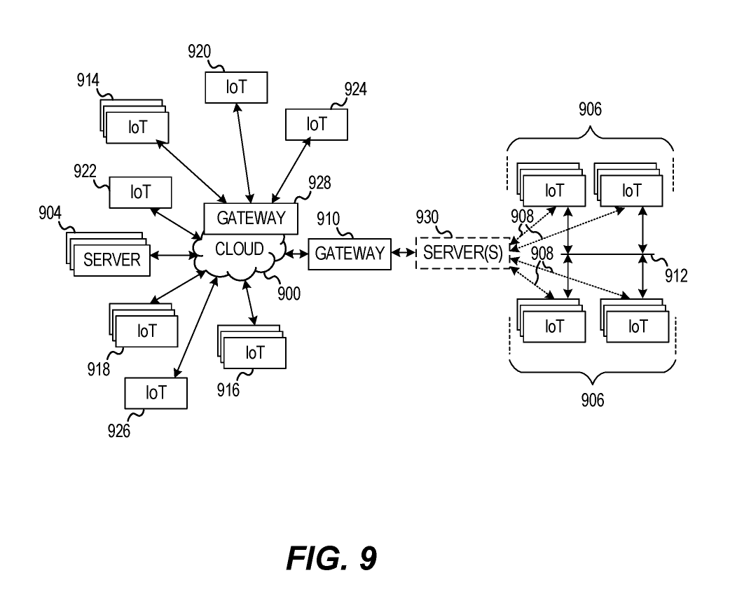

FIG. 9 illustrates a drawing of a cloud computing network, or cloud 900, in communication with a number of Internet of Things (IoT) devices. The cloud 900 may represent the Internet, or may be a local area network (LAN), or a wide area network (WAN), such as a proprietary network for a company. The IoT devices may include any number of different types of devices, grouped in various combinations. For example, a traffic control group 906 may include IoT devices along streets in a city. These IoT devices may include stoplights, traffic flow monitors, cameras, weather sensors, and the like. The traffic control group 606, or other subgroups, may be in communication with the cloud 900 through wired or wireless links 908, such as LPWA links, optical links, and the like. Further, a wired or wireless sub-network 912 may allow the IoT devices to communicate with each other, such as through a local area network, a wireless local area network, and the like. The IoT devices may use another device, such as a gateway 910 or 928 to communicate with remote locations such as the cloud 900; the IoT devices may also use one or more servers 930 to facilitate communication with the cloud 900 or with the gateway 910. For example, the one or more servers 930 may operate as an intermediate network node to support a local edge cloud or fog implementation among a local area network. Further, the gateway 928 that is depicted may operate in a cloud-to-gateway-to-many edge devices configuration, such as with the various IoT devices 914, 920, 924 being constrained or dynamic to an assignment and use of resources in the cloud 900.

Other example groups of IoT devices may include remote weather stations 914, local information terminals 916, alarm systems 918, automated teller machines 920, alarm panels 922, or moving vehicles, such as emergency vehicles 924 or other vehicles 926, among many others. Each of these IoT devices may be in communication with other IoT devices, with servers 904, with another IoT fog device or system (not shown, but depicted in FIG. 7), or a combination therein. The groups of IoT devices may be deployed in various residential, commercial, and industrial settings (including in both private or public environments).

As can be seen from FIG. 9, a large number of IoT devices may be communicating through the cloud 900. This may allow different IoT devices to request or provide information to other devices autonomously. For example, a group of IoT devices (e.g., the traffic control group 906) may request a current weather forecast from a group of remote weather stations 914, which may provide the forecast without human intervention. Further, an emergency vehicle 924 may be alerted by an automated teller machine 920 that a burglary is in progress. As the emergency vehicle 924 proceeds towards the automated teller machine 920, it may access the traffic control group 906 to request clearance to the location, for example, by lights turning red to block cross traffic at an intersection in sufficient time for the emergency vehicle 924 to have unimpeded access to the intersection.

Clusters of IoT devices, such as the remote weather stations 914 or the traffic control group 906, may be equipped to communicate with other IoT devices as well as with the cloud 900. This may allow the IoT devices to form an ad-hoc network between the devices, allowing them to function as a single device, which may be termed a fog device or system (e.g., as described above with reference to FIG. 7).

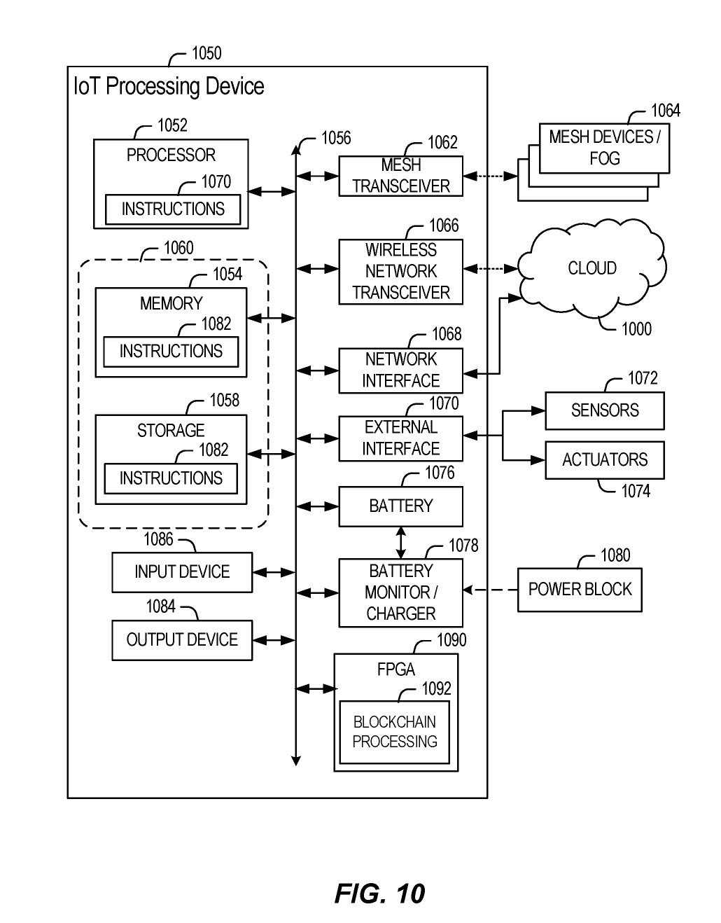

FIG. 10 is a block diagram of an example of components that may be present in an IoT device 1050 for implementing the techniques described herein. The IoT device 1050 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1050, or as components otherwise incorporated within a chassis of a larger system. Additionally, the block diagram of FIG. 10 is intended to depict a high-level view of components of the IoT device 1050. However, some of the components shown may be omitted, additional components may be present, and different arrangement of the components shown may occur in other implementations.

The IoT device 1050 may include a processor 1052, which may be a microprocessor, a multi-core processor, a multithreaded processor, an ultra-low voltage processor, an embedded processor, or other known processing element. The processor 1052 may be a part of a system on a chip (SoC) in which the processor 1052 and other components are formed into a single integrated circuit, or a single package, such as the Edison™ or Galileo™ SoC boards from Intel. As an example, the processor 1052 may include an Intel® Architecture Core™ based processor, such as a Quark™, an Atom™ an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1052 may communicate with a system memory 1054 over an interconnect 1056 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example the storage 1058 may be implemented via a solid state disk drive (SSDD). Other devices that may be used for the storage 1058 include flash memory cards, such as SD cards, microSD cards, xD picture cards, and the like, and USB flash drives. In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in a SoC based system. Other bus systems may be included, such as an I2C interface, an SPI interface, point to point interfaces, and a power bus, among others.

The interconnect 1056 may couple the processor 1052 to a mesh transceiver 1062, for communications with other mesh devices 1064. The mesh transceiver 1062 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1064. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1062 may communicate using multiple standards or radios for communications at different range. For example, the IoT device 1050 may communicate with close devices, e.g., within about 10 meters, using a local transceiver based on BLE, or another low power radio, to save power. More distant mesh devices 1064, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1066 may be included to communicate with devices or services in the cloud 1000 via local or wide area network protocols. The wireless network transceiver 1066 may be a LPWA transceiver that follows the IEEE 802.15.4, or IEEE 802.15.4g standards, among others. The IoT device 1050 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1062 and wireless network transceiver 1066, as described herein. For example, the radio transceivers 1062 and 1066 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1062 and 1066 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 766, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1068 may be included to provide a wired communication to the cloud 1000 or to other devices, such as the mesh devices 1064. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to allow connect to a second network, for example, a NIC 1068 providing communications to the cloud over Ethernet, and a second NIC 1068 providing communications to other devices over another type of network.

The interconnect 1056 may couple the processor 1052 to an external interface 1070 that is used to connect external devices or subsystems. The external devices may include sensors 1072, such as accelerometers, level sensors, flow sensors, optical light sensors, camera sensors, temperature sensors, a global positioning system (GPS) sensors, pressure sensors, barometric pressure sensors, and the like. The external interface 1070 further may be used to connect the IoT device 1050 to actuators 1074, such as power switches, valve actuators, an audible sound generator, a visual warning device, and the like.

In some optional examples, various input/output (I/O) devices may be present within, or connected to, the IoT device 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1050.

A battery 1076 may power the IoT device 1050, although in examples in which the IoT device 1050 is mounted in a fixed location, it may have a power supply coupled to an electrical grid. The battery 1076 may be a lithium ion battery, or a metal-air battery, such as a zinc-air battery, an aluminum-air battery, a lithium-air battery, and the like.

A battery monitor/charger 1078 may be included in the IoT device 1050 to track the state of charge (SoCh) of the battery 1076. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) convertor that allows the processor 1052 to directly monitor the voltage of the battery 1076 or the current flow from the battery 1076. The battery parameters may be used to determine actions that the IoT device 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the IoT device 1050. A wireless battery charging circuit, such as an LTC4020 chip from Linear Technologies of Milpitas, Calif., among others, may be included in the battery monitor/charger 1078. The specific charging circuits chosen depend on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine readable medium 1060 including code to direct the processor 1052 to perform electronic operations in the IoT device 1050. The processor 1052 may access the non-transitory, machine readable medium 1060 over the interconnect 1056. For instance, the non-transitory, machine readable medium 1060 may be embodied by devices described for the storage 1058 of FIG. 10 or may include specific storage units such as optical disks, flash drives, or any number of other hardware devices. The non-transitory, machine readable medium 1060 may include instructions to direct the processor 1052 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

In an embodiment, network interface device 1068 may include instructions to implement broker/Blockchain functionality (e.g., FIG. 2, 240) as embedded instructions. Similarly, it should be understood that instructions to implement the broker/Blockchain functionality 240 may be implemented as instructions 1082 in machine readable storage medium 1058, in a secure or isolated storage area. For instance, instructions 1082 may be encrypted when outside of a TEE or secure embedded controller such as network interface 1068. In an embodiment, a field programmable gate array (FGPA) 1090 may be programmed to implement the broker/Blockchain functionality 1092, or other subsystem implementing a portion of the functionality described herein. In an embodiment, the FPGA 1090 may be connected through a subsidiary bus to memory 1060, or any of the network controllers 1062, 1066, 1068, or both. In an example, the FPGA 1090 may have direct memory access to communications buffers.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for a smart city commodity exchange, according to embodiments and examples described herein.

Example 1 is a consumer node, comprising: a processor coupled to a block data storage device; a consumer miner agent operable by the processor and executing in a trusted execution environment, the consumer miner agent to: send a service request to a smart city commodity exchange network; commit resources necessary to complete the service request; negotiate via the smart city commodity exchange network with a provider miner agent operable by a service provider node for one or more goods or services; responsive to an agreement between the consumer miner agent and provider miner agent, generate a smart contract that includes, terms of the agreement, and store the smart contract on the block data storage device; broadcast a ledger having details about the smart contract and transaction information to the smart city commodity exchange network using Blockchain protocols.

In Example 2, the subject matter of Example 1 includes, wherein, the service provider node is to commit resources promised in an offer made during the negotiation until the transaction is completed, or the consumer node rejects the offer.

In Example 3, the subject matter of Examples 1-2 includes, wherein the consumer miner agent is to automatically accept an offer for services, responsive to the service request, that meets conditions of the request.

In Example 4, the subject matter of Examples 1-3 includes, wherein, responsive to committing of resources, a ledger entry is both stored in the block data storage device and broadcast to the smart city commodity exchange network using Blockchain protocols.

In Example 5, the subject matter of Examples 1-4 includes, wherein the consumer miner agent is further to receive an indication of level of fulfillment of the smart contract, by a fulfillment agent communicatively coupled to the processor, wherein the fulfillment agent uses sensor or data collection information to determine whether one or more conditions of the smart contract have been met and generate a level of fulfillment of the smart contract.

In Example 6, the subject matter of Example 5 includes, wherein the consumer miner agent is to record the indication of level of fulfillment as a ledger in the block data storage device, where the smart contract is marked as complete, and the ledger is broadcast to the smart city commodity exchange network, and wherein the ledger recordation automatically triggers payment of the contract and release of unused or excess committed resources.

In Example 7, the subject matter of Examples 1-6 includes, wherein the service request comprises identification of at least one good or service requested, and one or more conditions or terms of the request, wherein the condition or terms include at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives.

Example 8 is a service provider node, comprising: a processor coupled to a block data storage device; a provider miner agent operable by the processor and executing in a trusted execution environment, the provider miner agent to: receive a service request from a smart city commodity exchange network; commit resources necessary to complete the service request; negotiate via the smart city commodity exchange network with a consumer miner agent operable by a consumer node, to provide one or more goods or services requested in the service request; responsive to an agreement between the consumer miner agent and provider miner agent, generate a smart contract that includes, terms of the agreement, and store the smart contract on the block data storage device; broadcast a ledger having details about the smart contract and transaction information to the smart city commodity exchange network using Blockchain protocols.

In Example 9, the subject matter of Example 8 includes, wherein the service provider node is to commit resources promised in an offer made during the negotiation until the transaction is completed, or the consumer node rejects the offer made by the service provider node.

In Example 10, the subject matter of Examples 8-9 includes, wherein the service provider node is to verify that the consumer miner agent has committed resources necessary to complete payment for an accepted offer before providing the goods or serviced outlined in the offer.

In Example 11, the subject matter of Examples 8-10 includes, wherein, responsive to committing of resources, a ledger entry is both stored in the block data storage device and broadcast to the smart city commodity exchange network using Blockchain protocols.

In Example 12, the subject matter of Examples 8-11 includes, wherein the service provider miner agent is further to receive an indication of level of fulfillment of the smart contract, by a fulfillment agent communicatively coupled to the network, wherein the fulfillment agent uses sensor or data collection information to determine whether one or more conditions of the smart contract have been met and generate a level of fulfillment of the smart contract.

In Example 13, the subject matter of Example 12 includes, wherein the one of the consumer miner agent or provider miner agent is to record the indication of level of fulfillment as a ledger and broadcast the ledger to the smart city commodity exchange network, where the smart contract is marked as complete, and wherein the ledger recordation automatically triggers payment of the contract and release of unused or excess committed resources.

In Example 14, the subject matter of Examples 8-13 includes, wherein the provider miner agent is to generate a bundled offer for goods or services for fulfillment by multiple service providers or vendors, where the bundled offer meets at least one condition of the service request.

In Example 15, the subject matter of Examples 8-14 includes, wherein the provider miner agent is to negotiate with a third party for discounts, coupons, reduced fees, or other incentives, in exchange for information about the consumer or smart contract transaction, wherein any release of personal information about the consumer is to be authorized in the smart contract.

In Example 16, the subject matter of Example 15 includes, wherein the third party is one of a governmental agency, tourist agency, research organization, regulatory agency, local chamber of commerce, trade association, or service provider conglomerate.

Example 17 is a computer implemented method for providing services in a smart city commodity exchange network, comprising: receiving a request for service from a consumer node over the smart city commodity exchange network, the request for service including identification of at least one good or service requested, and one or more conditions or terms of the request, wherein the one or more conditions or terms include, at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives; providing an offer to the consumer node via the smart city commodity exchange network; committing resources included in the offer; responsive to receiving a response to the offer, from the consumer node, negotiating with the consumer node by a provider node from within a trusted execution environment, wherein the negotiating results in one of an acceptance of the offer, a rejection to the offer, a counter-offer, acceptance of the counter-offer, or rejection of the counter-offer; and responsive to acceptance of the offer or counter offer, generating a smart contract including terms and conditions of the accepted offer or counter-offer, wherein the smart contract and transactions pursuant to the negotiating are recorded in public ledgers in the smart city commodity exchange network according to Blockchain protocols.

In Example 18, the subject matter of Example 17 includes, providing goods or services as outlined in the smart contract; automatically receiving a payment, responsive to completion of the smart contract, based on public ledger entries made pursuant to performance of the terms and conditions of the smart contract.

In Example 19, the subject matter of Example 18 includes, wherein the payment is automatically adjusted based on a determination of a fulfillment level of the smart contract.

In Example 20, the subject matter of Example 19 includes, wherein determining the fulfillment level of the smart contract uses sensor or data collection information corresponding to the terms and conditions of the smart contract to determine whether each term and condition of the smart contract has been met.

Example 21 is at least one computer readable storage medium having instructions stored thereon, the instructions when executed on at least one processor cause the at least one processor to: receive a request for service from a consumer node over a smart city commodity exchange network, the request for service including identification of at least one good or service requested, and one or more conditions or terms of the request, wherein the one or more conditions or terms include, at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives; provide an offer to the consumer node via the smart city commodity exchange network; commit resources included in the offer; responsive to receiving a response to the offer, from the consumer node, negotiate with the consumer node by a provider node from within a trusted execution environment, wherein the negotiating results in one of an acceptance of the offer, a rejection to the offer, a counter-offer, acceptance of the counter-offer, or rejection of the counter-offer; and responsive to acceptance of the offer or counter offer, generate a smart contract including terms and conditions of the accepted offer or counter-offer, wherein the smart contract and transactions pursuant to the negotiating are recorded in public ledgers in the smart city commodity exchange network according to Blockchain protocols.

In Example 22, the subject matter of Example 21 includes, instructions to: automatically receive a payment, responsive to an indication of completion of the smart contract, based on public ledger entries made pursuant to performance of the terms and conditions of the smart contract.

In Example 23, the subject matter of Example 22 includes, wherein the payment is automatically adjusted based on a determination of a fulfillment level of the smart contract.

In Example 24, the subject matter of Example 23 includes, wherein determining the fulfillment level of the smart contract uses sensor or data collection information corresponding to the terms and conditions of the smart contract to determine whether each term and condition of the smart contract has been met.

Example 25 is a system for providing services in a smart city commodity exchange network, comprising: means for receiving a request for service from a consumer node over the smart city commodity exchange network, the request for service including identification of at least one good or service requested, and one or more conditions or terms of the request, wherein the one or more conditions or terms include, at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives; means for providing an offer to the consumer node via the smart city commodity exchange network; means for committing resources included in the offer; means for negotiating with the consumer node by a provider node from within a trusted execution environment, responsive to receiving a response to the offer, from the consumer node, wherein the means for negotiating results in one of an acceptance of the offer, a rejection to the offer, a counter-offer, acceptance of the counter-offer, or rejection of the counter-offer; and means for generating a smart contract including terms and conditions of the accepted offer or counter-offer, responsive to acceptance of the offer or counter offer, wherein the smart contract and transactions pursuant to the negotiating are recorded in public ledgers in the smart city commodity exchange network according to Blockchain protocols.

In Example 26, the subject matter of Example 25 includes, means for providing goods or services as outlined in the smart contract; means for automatically receiving a payment, responsive to completion of the smart contract, based on public ledger entries made pursuant to performance of the terms and conditions of the smart contract.

In Example 27, the subject matter of Example 26 includes, wherein the payment is automatically adjusted based on a determination of a fulfillment level of the smart contract.

In Example 28, the subject matter of Example 27 includes, wherein the means for determining the fulfillment level of the smart contract uses sensor or data collection information corresponding to the terms and conditions of the smart contract to determine whether each term and condition of the smart contract has been met.

Example 29 is a system configured to perform operations of any one or more Examples 1-28.

Example 30 is a method for performing operations of any one or more of Examples 1-28.

Example 31 is at least one machine readable medium including instructions that, when executed by a machine cause the machine to perform the operations of any one or more of Examples 1-28.

Example 32 is a system comprising means for performing the operations of any one or more of Examples 1-28.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A consumer node, comprising:
a processor coupled to a block data storage device;
a consumer miner agent operable by the processor and executing in a trusted execution environment, the consumer miner agent to:
send a service request to a smart city commodity exchange network;
commit resources necessary to complete the service request;
negotiate via the smart city commodity exchange network with a provider miner agent operable by a service provider node for goods or services;
responsive to an agreement between the consumer miner agent and provider miner agent, generate a smart contract that includes terms of the agreement, and store the smart contract on the block data storage device;
broadcast a ledger having details about the smart contract and transaction information to the smart city commodity exchange network using Blockchain protocols.

2. The consumer node as recited in claim 1, wherein, the service provider node is to commit resources promised in an offer made during the negotiation until the transaction is completed, or the consumer node rejects the offer.

3. The consumer node as recited in claim 1, wherein the consumer miner agent is to automatically accept an offer for services, responsive to the service request, that meets conditions of the request.

4. The consumer node as recited in claim 1 wherein, responsive to committing of resources, a ledger entry is both stored in the block data storage device and broadcast to the smart city commodity exchange network using Blockchain protocols.

5. The consumer node as recited in claim 1, wherein the consumer miner agent is further to receive an indication of level of fulfillment of the smart contract, by a fulfillment agent communicatively coupled to the processor, wherein the fulfillment agent uses sensor or data collection information to determine whether one or more conditions of the smart contract have been met and generate a level of fulfillment of the smart contract.

6. The consumer node as recited in claim 5, wherein the consumer miner agent is to record the indication of level of fulfillment as a ledger in the block data storage device, where the smart contract is marked as complete, and the ledger is broadcast to the smart city commodity exchange network, and wherein the ledger recordation automatically triggers payment of the contract and release of unused or excess committed resources.

7. The consumer node as recited in claim 1, wherein the service request comprises identification of at least one good or service requested, and one or more conditions or terms of the request, wherein the condition or terms include at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives.

8. A service provider node, comprising:
a processor coupled to a block data storage device;
a provider miner agent operable by the processor and executing in a trusted execution environment, the provider miner agent to:
receive a service request from a smart city commodity exchange network;
commit resources necessary to complete the service request;
negotiate via the smart city commodity exchange network with a consumer miner agent operable by a consumer node, to provide one or more goods or services requested in the service request;
responsive to an agreement between the consumer miner agent and provider miner agent, generate a smart contract that includes terms of the agreement, and store the smart contract on the block data storage device;
broadcast a ledger having details about the smart contract and transaction information to the smart city commodity exchange network using Blockchain protocols.

9. The service provider node as recited in claim 8, wherein the service provider node is to commit resources promised in an offer made during the negotiation until the transaction is completed, or the consumer node rejects the offer made by the service provider node.

10. The service provider node as recited in claim 8, wherein the service provider node is to verify that the consumer miner agent has committed resources necessary to complete payment for an acceptance of an offer before providing the goods or serviced outlined in the offer.

11. The service provider node as recited in claim 8 wherein, responsive to committing of resources, a ledger entry is both stored in the block data storage device and broadcast to the smart city commodity exchange network using Blockchain protocols.

12. The service provider node as recited in claim 8, wherein the service provider miner agent is further to receive an indication of level of fulfillment of the smart contract, by a fulfillment agent communicatively coupled to the network, wherein the fulfillment agent uses data collection information to determine whether conditions of the smart contract have been met and generate a level of fulfillment of the smart contract.

13. The service provider node as recited in claim 12, wherein one of the consumer miner agent or provider miner agent is to record the indication of level of fulfillment as a ledger and broadcast the ledger to the smart city commodity exchange network, where the smart contract is marked as complete, and wherein the ledger recordation automatically triggers payment of the contract and release of unused or excess committed resources.

14. The service provider node as recited in claim 8, wherein the provider miner agent is to generate a bundled offer for goods or services for fulfillment by multiple service providers or vendors, where the bundled offer meets at least one condition of the service request.

15. The service provider node as recited in claim 8, wherein the provider miner agent is to negotiate with a third party for discounts, coupons, reduced fees, or other incentives, in exchange for information about the consumer or smart contract transaction, wherein any release of personal information about the consumer is to be authorized in the smart contract.

16. The service provider node as recited in claim 15, wherein the third party is one of a governmental agency, tourist agency, research organization, regulatory agency, local chamber of commerce, trade association, or service provider conglomerate.

17. A computer implemented method for providing services in a smart city commodity exchange network, comprising:
receiving a request for service from a consumer node over the smart city commodity exchange network, the request for service including identification of at least one good or service requested, and one or more conditions or terms of the request, wherein the one or more conditions or terms include at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives;
providing an offer to the consumer node via the smart city commodity exchange network;
committing resources included in the offer;
responsive to receiving a response to the offer, from the consumer node, negotiating with the consumer node by a provider node from within a trusted execution environment, wherein the negotiating results in one of an acceptance of the offer, a rejection to the offer, a counter-offer, acceptance of the counter-offer, or rejection of the counter-offer; and
responsive to acceptance of the offer or counter offer, generating a smart contract including terms and conditions of the accepted offer or counter-offer, wherein the smart contract and transactions pursuant to the negotiating are recorded in public ledgers in the smart city commodity exchange network according to Blockchain protocols.

18. The method as recited in claim 17, further comprising:
providing goods or services as outlined in the smart contract;
automatically receiving a payment, responsive to completion of the smart contract, based on public ledger entries made pursuant to performance of the terms and conditions of the smart contract.

19. The method as recited in claim 18, wherein the payment is automatically adjusted based on a determination of a fulfillment level of the smart contract.

20. The method as recited in claim 19, wherein determining the fulfillment level of the smart contract uses sensor or data collection information corresponding to the terms and conditions of the smart contract to determine whether each term and condition of the smart contract has been met.

21. At least one non-transitory computer readable storage medium having instructions stored thereon, the instructions when executed on at least one processor cause the at least one processor to:
receive a request for service from a consumer node over a smart city commodity exchange network, the request for service including identification of at least one good or service requested, and one or more conditions or terms of the request, wherein the one or more conditions or terms include at least one of a desired geographical location, a series of activities to be performed in a time period, discounts/refund for partial or complete fulfillment failure, alternative services in exchange for failed fulfillment, discounts responsive to occurrence of a pre-condition, fee/cost maximum, or authorization to release personal or location information in exchange for incentives;
provide an offer to the consumer node via the smart city commodity exchange network;
commit resources included in the offer;
responsive to receiving a response to the offer, from the consumer node, negotiate with the consumer node by a provider node from within a trusted execution environment, wherein the negotiating results in one of an acceptance of the offer, a rejection to the offer, a counter-offer, acceptance of the counter-offer, or rejection of the counter-offer; and
responsive to acceptance of the offer or counter offer, generate a smart contract including terms and conditions of the accepted offer or counter-offer, wherein the smart contract and transactions pursuant to the negotiating are recorded in public ledgers in the smart city commodity exchange network according to Blockchain protocols.

22. The at least one computer readable storage medium as recited in claim 21, further comprising instructions to:
automatically receive a payment, responsive to an indication of completion of the smart contract, based on public ledger entries made pursuant to performance of the terms and conditions of the smart contract.

23. The at least one computer readable storage medium, as recited in claim 22, wherein the payment is automatically adjusted based on a determination of a fulfillment level of the smart contract.

24. The at least one computer readable storage medium, as recited in claim 23, wherein determining the fulfillment level of the smart contract uses sensor or data collection information corresponding to the terms and conditions of the smart contract to determine whether each term and condition of the smart contract has been met.
